(19) United States
(12) Patent Application Publication
(10) Pub. No.: US 2026/0271970 A1
(43) Pub. Date: Sep. 17, 2026

(54) FEED FOR LARVAE OF AQUATIC ANIMALS

(71) Applicant: PLANKTONIC AS, Trondheim (NO)

(72) Inventors: Nils Egil TOKLE, Trondheim (NO); Håvard Johan AAKERØY, Trondheim (NO)

(73) Assignee: PLANKTONIC AS, Trondheim (NO)

(21) Appl. No.: 19/471,895

(22) PCT Filed: Apr. 4, 2024
(86) PCT No.: PCT/NO2024/050081

§ 371 Date: Oct. 2, 2025

(30) Foreign Application Priority Data
Apr. 4, 2023 (NO) 20230380

(51) Int. Cl. A23K 50/80; A01K 61/54; A23K 10/20; A23K 30/00

(52) U.S. Cl. CPC A23K 50/80; A01K 61/54; A23K 10/20; A23K 30/00

(57) ABSTRACT

The present invention relates to a feed for aquatic animals, comprising preserved eggs and/or trochophores of Bivalvia. The invention further relates to use of preserved eggs and/or trochophores of Bivalvia as feed for aquatic animal consumption, wherein the feed is given to the farmed aquatic animal from 0 to 10 days after hatch. The invention further relates to a method for harvesting eggs from Bivalvia, comprising steps for
arranging living Bivalvia in water in a container,
stressing and/or triggering the Bivalvia to release eggs, and
separating the eggs from the water.

The invention further relates to a method for preserving eggs and/or trochophores of Bivalvia, comprising the following steps:
heating seawater to 50-100 degrees Celsius,
adding eggs and/or trochophores to seawater,
keeping the eggs and/or trochophores in the water for 1-60 seconds, and
separating water from eggs and/or trochophores.

The present invention relates to a feed for aquatic animals, according to the preamble of the independent claim 1. The present invention also relates methods for harvesting, preserving and use of eggs and/or trochophores of Bivalvia.

### BACKGROUND

In the past decades, there has been a strong focus to develop and identify new resources for marine raw material and nutritional products. Increasing fish farming activities lead to a high demand for marine raw materials that are suitable to be used as a feed. In addition, research has focused on the lack of suitable diets for farming of early live stages of marine organisms such as marine fish larvae, especially replacements diets for live prey organisms.

High mortality rates, suboptimal growth and mal-developments during initial cultivation of marine fish larvae have been a tremendous challenge for the cultivation of many fish species. This is considered to be one of the main bottle necks for successful commercial exploitation in fish farming. The natural diet of marine fish larvae are typically small planktonic crustaceans such as copepods. As their abundance in the sea is restricted to certain times of the year and their intensive cultivation for aquaculture purposes proved difficult, copepods as a natural resource of live prey are hardly used in aquaculture. Since artificial diets and non-living diets proved to be inefficient or suboptimal for marine fish larvae, selected live feed organisms have been cultivated and enriched instead. Only two zooplankton families have so far shown that they can be produced regularly at an acceptable cost, that is the brine shrimp Artemia and the rotifer Brachionus sp.

However, even though vast attempts have been carried out to improve the nutritional value of these organisms by different enrichment techniques, they are still found unsatisfactory to support optimal development and growth. Additionally, their cultivation is demanding and cost-intensive. However, artificial diets still generally result in lower survival and fish larval quality. Thus, there is clearly a need for new marine resources and especially for alternative high quality marine resources suitable as start feed replacing live feed organisms.

Most aquatic organisms have a larvae stage in the start of their life cycle. Larvae of marine fish have a very simple digestion system, and require that the presented prey item has a balanced nutrition with a proper content of protein, phospholipid rich in marine highly unsaturated fatty acids, vitamins and minerals. Phospholipids rich in highly unsaturated fatty acids are one of the requirements, and not possible to fully achieve when using rotifers, Artemia or formulated dry micro diets. The size of the prey is also of importance, as the larvae are small mouthed. Dry feeds with small size are possible to produce, but not with the suitable biochemical properties. Small dry feeds with a large surface to volume ratio, do have a high leakage of nutrients. Leaked nutrients are excellent growth substrate for bacteria, and such conditions will eventually be lethal to the fish.

Inadequate feeding during the first life stages of marine fish larvae such as the Atlantic cod, Atlantic halibut and turbot may result in reduced growth, but also in high mortality rates, decreased larval quality, mal pigmentations and mal developments. Moreover, these life stages need small prey items and have very high nutritional demands. Marine fish larvae as well as larval shrimps are normally pelagic organisms living in the water column, and depend on prey/feed particles suspended and staying in the water column until they are consumed.

Feed having a high content of marine unsaturated fatty acids has proven to be beneficial for the normal development and nutritional quality of many cultured aquatic species used for human consumption. Today, the cultivation of many marine fish and crustacean species largely depends on feeding of living prey during their first developmental stages.

In aquaculture, the most common prey organisms used to feed marine fish larvae are belonging to the group of rotifers especially some species belonging to the family of Brachionidae and to the brine shrimp Artemia (the only genus in the family Artemiidae). However, the nutritional composition of rotifers and Artemia is naturally poor and must be enriched with marine lipids, especially omega-3 fatty acids to improve their nutritional quality as prey organisms for marine fish larvae. But despite of the mentioned enrichment, both Artemia and rotifers are still not found nutritionally optimal for many larval species. This is reflected in mortality rates, growth rates, mal pigmentations and mal developments. Thus, there is a clear need for more optimal replacement diets for first feeding larvae as well as for early life stages of many cultivated aquatic animals.

In EP 2916664 it is described an animal feed comprising eggs and/or nauplii of stage I of a barnacle. The eggs of barnacle may however be too large to eat for larvae of several species. Further, the eggs are not easily accessible.

### Object

One object of the present invention is to provide a new biological resource for nutritional products such as feed, as well as methods for the exploitation of a new marine biological resource which can be industrially applied for different purposes. Thus, another object of the present invention is to provide a new biological resource for marine based products, and a method for exploiting and producing it.

A further object is to provide the new biological resource for the marine based product in a particular pure form without being mixed with other biological material. In particular, a further object of the present invention is to provide an optimized diet useful for feeding aquatic animals such as fish and crustaceans, especially in their early life stages.

The newly hatched fish larvae are typically from 1.5-5 mm long, and weigh about 0.01 to 0.2 mg dry weight per individual, but those values can deviate as there is a tremendous biodiversity and early live cycle strategies among finfish and other aquatic animals. Another object of the present invention is thus to provide a feed having a suitable size for the fish larvae to eat, more specific, the units of the feed must not be larger than 100 μm, as many potential aquaculture species are small mouthed. For larvae of several species of groupers and snappers, the preferred size of the first prey is smaller than 100 μm, and preferably 70-80 μm.

Another object of the invention is to provide a feed for fish larvae based on biological resources being easily accessible, and further that the feed should be easily accessible to the fish larvae.

Another object of the invention is to provide a feed being robust and stable, able to be introduced into the larval cultivation units without leaking nutrients to the water in the fish tank. Leaked nutrients from feeds are a major growth substrate for micro-organisms in aquaculture.

Another object of the invention is to provide a feed being easy to transport, store, handle and dose for a fish farmer.

Yet another object of the invention is to provide a feed having satisfactory or sufficient nutritional value.

### The Invention

The above said objects and needs are solved by a feed, methods and use according to the characterizing part of the independent claims. Further advantageous features are stated in the corresponding dependent claims.

The invention relates to a feed for aquatic animals, wherein the feed comprises preserved eggs and/or trochophores of Bivalvia. The eggs and/or trochophores are preserved to prevent any further development. The eggs and trochophores should be prevented from developing to further stages, as further stages may comprise a shell of calcium carbonate, which may be more difficult to digest for the larvae.

The feed may comprise not living developmental meaning non-living eggs and trochophores. The eggs and trochophores may be dead but still intact, and having the same or very similar biochemical contents and nutritional value as living eggs and trochophores. The eggs and/or trochophores may be fed to the larvae as single eggs/trochophores or in a composition dissolved to single eggs/trochophores in water before or at feeding.

Further, the eggs should be prevented from breaking and/or leaking upon handling. This will both preserve the nutrition value, and prevent growth of bacteria in the system. Non preserved eggs will start developing after about 20 minutes in water having about 10 degrees Celsius. At about 30 degrees Celsius, which is a regular temperature upon farming tropical fish and shrimps, the eggs will start leaking after a few seconds.

The eggs and trochophores may be preserved by direct freezing, freeze-drying, pasteurising, using of chemicals, sterilizing by using autoclave, cold plasma, pulsed electric field, radiation, high pressure processing and/or UV treatment. Possible chemicals may be microbial inhibitors, such as Sodium benzoate, Potassium sorbate and/or sodium chloride.

The eggs and trochophores may be preserved by heating in water. The eggs and trochophores may be transferred to water having a temperature of 50-100 degrees Celsius. The water may have a temperature of 50-75 degrees, or 55-65 degrees, or even a temperature of 62 degrees Celsius. The eggs and trochophores may be kept at this temperature for 1-60 seconds, or a period of 1-10 seconds.

The eggs and trochophores may be preserved by heating by means of hot air, electromagnetic radiation such as microwaves or by using an autoclave.

If the eggs are heated too long or becomes too warm, they may cluster to each other and create a bundle of eggs. A bundle of eggs may not be eatable for a larva of an aquatic animal. Further, the treatment of the eggs and trochophores should have minimal effects on the nutritional value of the feed, such as the vitamins and/or proteins.

Preserved eggs will be sufficiently robust to be handled and transported. As the eggs are robust, the biosafety is increased.

The aquatic animals to eat the feed may be larvae of fish, Crustacea, Anthozoa and/or Mollusca. More specific, the animals may be larvae of farmed aquatic animals, for instance larvae of fish such as Ballan wrasse, sea bass or cod. More specific, the animals may by larvae of crustacea such as tropical shrimps (Litopenaeus vannamei and Penaeus monodon) other shrimp species, lobsters, or larvae of mollusca such as squid, cuttlefish and octopus.

The feed comprising eggs and/or trochophores may be prepared as pellets, as pellets are easy to handle and disperse to the aquatic animals. This means that one pellet may contain several thousand eggs. The pellets may have a size of 0.1-1 cm or 0.3-0.6 cm for a fish larvae. A pellet may be spherical, cylindrical or any other shape, having the same or a different length in different directions, or dimensions. The term “size”, as used herein, refers to the length of the longest direction or dimension of the pellet.

The pellets may be stored frozen, at a temperature below 0. Once the pellet of eggs is supplied to the larval tank, it will immediately dissolve, and the single eggs will be spread evenly in the upper water column of the tank. Another way of preparing the eggs for the fish larvae, is to add the eggs in a bucket with water, preferably seawater or brackish water. The pellets will dissolve in a few seconds/minutes (depending of the amount added per liter), and each single egg will be evenly dispersed in the water column. Thereafter, the eggs can be supplied to the fish tank, either by hand-feeding or by using a pump for dosing the eggs over a longer period of time.

It may be more convenient to produce pellets when the eggs and/or trochophores contain some water, and the solid content of the pellets may be 1-25 percent, or preferably 5-12%. Further, it may be an advantage to produce pellets containing a defined number of eggs and/or trochophores per gram, this may also ease calculations upon feeding. For instance, when one should add 50 eggs per milliliter water in a container, it may be easier for a fish farmer when it is defined that the feed comprises 2 billion eggs/kg. The same regards trochophores, or a combination of eggs and trochophores.

In another aspect, the invention relates to use of preserved eggs and/or trochophores of Bivalvia as feed for aquatic animal consumption. The nutrition value of feed is very important in general, and specially for larvae of aquatic animals as described above. Eggs of Bivalvia has high nutritional value and comprises the important omega 3 fatty acids, and especially what is referred to as HUFA's—Highly unsaturated fatty acids such as DHA, EPA and ARA fatty acids. The lipid composition of the eggs are given in table 1 below.

| | % Fatty Acids of Total | % of Dry | mg//kg Dry |
|---|---|---|---|
| | Fatty Acids | Weight | Weight |
| Lipids | | 17.7 | |
| Proteins | | 59.6 | |
| Carbohydrates | | 7 | |
| Vitamin E | | | 157 |
| Fatty acids | | | |
| 20:4n6, ARA | 0.91 | | |
| 22:5n3, EPA | 13.75 | | |
| 22:6n3, DHA | 11.55 | | |
| Total n3 PUFA | 36.05 | | |

A use of preserved eggs and/or trochophores of Bivalvia according to the invention, may be feeding the eggs to an aquatic animal directly or comprised in a feed with other ingredients.

The use of preserved eggs of Bivalvia may be feeding the eggs to an aquatic animal from hatch, or from the first day the larvae start to eat. This means that the eggs will be given as the first feed. The eggs may be fed to the aquatic animals for a few days, such as at least the first 10 days from start of feeding, depending on the type of animal. The eggs may be given to the animals also in their juvenile and adult stage.

In another aspect, the invention relates to a method for harvesting eggs from Bivalvia. The method comprises the following steps:
a) arranging living Bivalvia in water in a container,
b) stressing and/or triggering the Bivalvia to release eggs,
c) separating the eggs from the water.

Bivalvia spawn natural in the period April-May-June in the northern hemisphere, but they may also spawn during summer and autumn. In the southern hemisphere, the spawning will often be in spring, which could be September-November, depending on geographical area. However, most Bivalvia, such as blue mussels, produce eggs continuously, and thus they may spawn over a long period of time. They also normally spawn as a response to stress, and by arranging living Bivalvia in water in a container, and stressing them, eggs will be released to the water surrounding the Bivalvia. When the Bivalvia spawn, they also release pheromones into the water, and the pheromones will trigger other Bivalvia of the same species to spawn. The water in the container will therefore contain eggs and pheromones, and the eggs may be harvested by separating water and eggs.

The eggs may be removed from the container continuously or intermittently, by letting eggs and water flow out of the container while the Bivalvia are still releasing eggs, or the eggs may remain in the container until the mussels no longer spawn. It may be an advantage to remove eggs and water continuously, as eggs which remain in the container too long, they may be eaten by the mussels.

When water and eggs are removed intermittently or continuously from the container, the eggs may be separated from the water for instance by flowing the mixture over a filter, sieve or the similar. The eggs normally have a size about 70 μm, and thus the mesh width of the filter needs to be less than 70 μm. The eggs may be fragile, and may burst or leak if they are not handled sufficiently gently when removed from the container and/or separated from the water. The filter and system should be designed accordingly.

In order to remove sufficiently amount of water and possibly any undesired articles, such as pieces of shell or debris, from the eggs, the filter may be arranged in several floors wherein undesired articles are filtered on the first floor, while eggs and water passes through. In the next floor only water passes through the filter, and the eggs will be remaining. The filters may be vibrating, removing even further water.

Water and eggs may be removed from the container by a pump, suction, spillway or gravitation by arranging the processing-devices following the container vertically lower than the container. The eggs may be fragile, and any handling must be performed sufficiently gentle to avoid breakage and/or leakage from the eggs.

As said above, when the Bivalvia spawn, they also release pheromones into the water, and the pheromones may trigger other Bivalvia of the same species to spawn. When the eggs are removed by letting eggs and water flow out of the container, the amount of pheromones in the water will be reduced, and the mussels may be less triggered to spawn. Water separated from the eggs as described above, may therefore be recirculated back to the container wherein the living Bivalvia are arranged, to trigger further spawning. In this way, one may get the Bivalvia to release all eggs. Bivalvia may spawn eggs corresponding to about 4-10% of their weight during a couple of days.

The Bivalvia may be stressed in different ways, for instance by fresh water, changes of the salinity of the water, water having a higher temperature and mechanical influence. Further, they may be triggered to spawn by pheromones from other Bivalvia.

The water in the container may be replaced continuously or at intervals, to keep a healthy environment for the Bivalvia. The water may also be treated and recirculated in addition to, or in combination with addition of new water. The replacement of water and how to keep a healthy environment for living organisms in a container is well known to a skilled person. The water separated from the eggs may be a added to the container in a separate inlet, or together with the replacement and/or recirculated water.

Not only eggs, but also trochophores or a combination of eggs and trochophores may be used as a feed. To harvest trochophores, the eggs may be transferred to a pool of water, for instance 1-50 grams egg per litre water. The water may contain some of the water separated from the eggs as mentioned above, as such water may contain sperm which may fertilize the eggs. The water should have a temperature of 5-25 degrees Celsius. The water should be stirred by a pump or bubbling of air to prevent that the eggs sediment. The eggs are held in the water for 1-24 hours, until a desired part of the eggs have developed to trochophores. The time necessary depends i.a. on the temperature. The trochophores are separated from the water in the same way as described above for separation of eggs, preferably by using a filter of 25 μm, and processed as described for the eggs.

Once the eggs and/or trochophores are isolated, they must be preserved before they may be used as feed for aquatic organisms. Another aspect of the invention relates to a method for preservation of eggs and/or trochophores of Bivalvia, and comprises the following steps:
i) adding the eggs and/or trochophores to seawater,
ii) heating the seawater to 50-100 degrees Celsius,
iii) keeping the eggs and/or trochophores in the water for 1-60 seconds,
iv) removing the eggs and/or trochophores from the water.

Step i) and ii) may be performed by adding the eggs and/or trochophores to sea water at ambient temperature and then heating the mixture to 50-100 degrees Celsius, or by heating the sea water to 50-100 degrees Celsius, and then adding the eggs and/or trochophores.

As said above, the eggs and/or trochophores must be preserved to avoid that they develop further into development stages, which may be less digestible for some of the larvae. Further, by preserving the eggs they become less fragile, and can withstand rougher handling and processing. When the preserved eggs are used as feed for aquatic animals, they will not break and leak to the surrounding water. As the eggs are whole and relatively stable, minor or no nutrients will leak into the water surrounding the aquatic animals and bacteria growth in the fish tank will be reduced compared to when using other feeds (both live feeds and dry diets). When preserving the eggs and/or trochophores according to the method above, the water may be heated in step II to a temperature of 50-75 degrees, or 55-65 degrees, or even to a temperature of 62 degrees Celsius. The eggs and/or trochophores may be kept at this temperature for 1-60 seconds, or a period of 1-10 seconds. Once the eggs and/or trochophores are sufficiently heated, they may be removed from the water, for instance by filtration as described above.

Another aspect of the invention is related to a method for producing a feed in the shape of a pellet for aquatic animals, comprising eggs and/or trochophores of Bivalvia. By producing a pellet of the eggs and/or trochophores, the feed may be more easily measured and handled by the farmer. The method comprises the following steps:
v) adding a small amount of water to eggs and/or trochophores harvested and preserved by the method described above,
vi) producing pellets,
vii) freezing the pellets containing the eggs and/or trochophores until use.

The pellets may be produced by adding droplets or larger units comprising eggs/sea water to a cold medium such as liquid nitrogen.

Water may be added to the eggs and/or trochophores until the mixture is flowing, such as equal amounts of water and eggs and/or trochophores by volume. Then the mixture may be dripped into floating nitrogen having a temperature of −196 degrees Celsius, and small pellets will be made. The pellets may be spherical having a diameter of 0.1-1 cm, more preferred 0.3-0.6 cm. The pellets are stored at this temperature until use.

Further ingredients may be added to the feed and/or the pellet.

Another aspect of the invention is related to a method for preparing a feed for aquatic animals, comprising eggs and/or trochophores of Bivalvia. The method comprises the following step:
viii) arranging the frozen pellets containing eggs produced by the methods described above, in a container with water having a temperature above 0 degrees Celsius.

The water may contain sea water, preferably in an amount less than the amount of seawater in the tank of aquatic animals to receive the feed. The pellet will dissolve into single eggs during the defrosting.

When the water wherein the pellets are defrosted, has lower content of seawater than the water surrounding the aquatic animals, the thawed eggs will be kept in the upper water column in the seawater surrounding the aquatic animals. The animals will have better access to the feed, and most of the eggs will be eaten. This will improve the economics of the farming. Further, as the pellets are preserved and kept suspended in the upper water column less nutrients will be released to the water in the farming tanks, and less sediments will settle on the bottom of the tank. Less nutrients and less sediments result in a cleaner water in the tank, and the walls and bottom of the tank needs less cleaning.

The particular features, structures or characteristics described above may be combined in any suitable manner in one or more embodiments.

### EXAMPLES

In the following embodiments of the present invention will be described in detail. The examples are given to elucidate the invention, and should not be used to interpret the invention limiting.

### Harvesting Eggs

In the present experiment, blue mussels (M. edulis) were used, however any Bivalvia may be used. The eggs of the blue mussels were given to fish larvae, however larvae of any aquatic animal may be fed with the eggs.

Living mussels were arranged in a container with seawater. Different methods may be used to trigger them to spawn simultaneously, in this experiment it was used warm freshwater to raise the temperature to about 15-20 degrees, and reduce the salinity i to about 15 parts per thousand parts. Once the first mussels started to spawn, the water was recircled and contained enough pheromones to trigger the remaining mussels to spawn without use of further fresh water.

Seawater was sprinkled over the mussels in the container, and water and egg were taken out continuously through an outlet in the container. The water and eggs were spread on a filter arranged in several steps whereby an upstream filter had a mesh width larger than the eggs, such as 90 micro meter, and the last filter had a mesh width less than 70 micro meter, such as 20 micro meter. The eggs having a diameter of about 70 micro meter will thus be collected on the last filter. Any particles larger than the eggs, such as pieces of shell and debris will be removed by the upstream filter, and any particles being smaller than the eggs will be removed by the water.

A water tank was arranged under the filter to collect the water flowing through the filter. The water was then recycled back to the container with the mussels, and, as the water contained pheromones, it triggered the mussels to further spawning.

The eggs were removed from the filter and transferred to a container with heated seawater. The eggs were preserved by heating at 62 degrees Celsius, for a period of 1-10 seconds.

Once the eggs were preserved, they were removed from the water, and some sterile or disinfected sea water was added to allow production of pellets from the eggs. The pellets were about 0.3-0.6 mm, and had a content of solids of about 5-12 dry weight %. The pellets were frozen on liquid Nitrogen, at about 196 degrees Celsius below zero.

When the eggs should be used, they were defrosted in water having a sea water content less than the water where the fish larvae were kept. In this experiment, the water wherein the eggs were defrosted had a sea water content of about of 0.5-2 percent, as and the water wherein the fish larvae were farmed had a sea water content of about 2.5-4.0 percent.

### Ballan Wrasse

The eggs were fed to larvae of Ballan wrasses in two different tests, according to the table below:

Fish tank of 2 m3, comprising larvae of Ballan wrasse (about 2000 larvae), were given the following feed:

| Days after | | |
|---|---|---|
| start | | |
| of eating | Feed experiment 1 | Feed experiment 2 |
| 1^{st} | Barnacle nauplii | Eggs of Mytilus |
| | | edulis |
| 2^{nd} | Eggs of M. edulis and Brachionus | Eggs of M. edulis |
| 3^{rd} | Eggs of M. edulis | Eggs of M. edulis |
| 4^{th} | Eggs of M. edulis | Eggs of M. edulis |
| 5^{th} | Eggs of M. edulis | Eggs of M. edulis |
| 6^{th} | Eggs of M. edulis and Barnacle nauplii | Eggs of M. edulis |
| 7^{th} | Barnacle nauplii | Eggs of M. edulis |

The fish larvae in the tanks had increased their weight and survival rate considerably compared to tanks only given enriched rotifers which is the regular feed. Fish larvae this young cannot survive without feed for three whole days, and thus the experiment clearly shows that the larvae ate eggs of Mytilus edulis.

Further, the fish tanks wherein the fish larvae were given eggs of M. edulis were much cleaner than tanks containing fish larvae fed with enriched rotifers. The tanks must normally be cleaned every day, but the tanks wherein eggs of M. edulis were used as feed did not need cleaning. This is because the eggs were robust and did not break and therefore less nutrients were accessible to any bacteria in the tank.

Further, the eggs did not sink as fast as regular feed, and therefore one did not get accumulation of feed at the bottom of the tank, which could give rise to growth of bacteria. The eggs were either eaten or washed out of the tank by the water flowing through the tank.

### Sea Bream:

A test in industrial scale was made at a fish farming plant in Greece. The test was performed on about 1.5 million fish larvae of Sea bream. Preserved eggs of M. edulis were given as the sole feed from the first day. Fish larvae were taken out and examined to investigate whether it had eaten any feed, and eventually how much it had eaten.

80% of the examined fish larvae had eaten the first day, while only 20% of the fish larvae ate when enriched rotifers were offered. The fish larvae fed with eggs of M. edulis grew considerably better than fish larvae only fed with enriched rotifers; the fish larvae given eggs of Bivalvia (M. edulis) grew about two days faster the first 10 days after hatching, with very low mortality rate. The digestion and degree of filling of the stomach and intestine was good during the whole period. Since feed and food intake is known to limit the development from eggs to juvenile, this difference is sensational and will have huge impact.

### Cod

Eggs of M. edulis were given to larvae of cod in an attractiveness test. The cod larvae ate and digested the eggs very well, and based on the results for ballan wrasse and sea bream above, it is expected improved growth and survival rate of the cod larvae as well.

In another experiment Atlantic cod juveniles were offered eggs of M. edulis the first feeding days and compared with cod offered enriched rotifers. It was used 9 experimental flow through tanks, each 400 litre, with newly hatched Atlantic cod (100 individuals per litre) with a control and two treatments (all in triplicates). The control treatment involved rotifers from first feeding day. One of the treatments involved M. edulis eggs the first 5 feeding days.

A histology analysis was done by the University of Patra in Greece. The Atlantic cod offered M. edulis eggs displayed better quality of the gut and liver, which can be interpreted as healthy intestines that can exploit and assimilate the ingested feed to growth. The eyes and gills of the cod fed M. edulis eggs were also of better quality compared to the control. At the end of the trial, the Atlantic cod offered M. edulis eggs displayed about 10% higher individual weight compared to the control, and 35% survival compared to the control which had a survival of 25%. It is very clear from this trial that the M. edulis eggs offer nutrients to the marine larvae that are limiting in rotifers.

1. A feed suitable for aquatic animals, comprising preserved, dead, intact eggs and/or trochophores of Bivalvia, having the same or very similar biochemical contents and nutritional value as living eggs and trochophore.

2. The feed according to claim 1, wherein the aquatic animals are larvae of fish, Crustacea and/or Mollusca.

3. The feed according to claim 1, wherein the aquatic animals are larvae of fish.

4. The feed according to claim 1, wherein the eggs and/or trochophores are preserved by direct freezing, freeze-drying, pasteurizing, using of chemicals, sterilization by using autoclave, cold plasma, pulsed electric field, radiation, high pressure processing and/or UV treatment.

5. The feed according to claim 4, characterized in that the eggs and/or trochophores are preserved by heating in water.

6. The feed according to claim 4 claim 4, wherein the eggs and/or trochophores are preserved by heating to a temperature of 50-100 degrees Celsius, and keeping the eggs and/or trochophores at this temperature for 1-60 seconds.

7. A method of feeding a farmed aquatic animal, the method comprising providing the feed according to claim 1, wherein the feed is provided to the farmed aquatic animal from 0 to 10 days after hatch.

8. A method for harvesting eggs from Bivalvia, the method comprising
1) arranging living Bivalvia in water in a container
2) stressing and/or triggering the Bivalvia to release eggs,
3) separating the eggs from the water,
4) introducing the water from step 3) into the container.

9. The method according to claim 8, wherein the eggs and water are removed from the container intermittently or continuously while the Bivalvia are releasing eggs.

10. A method for preserving eggs and/or trochophores of Bivalvia suitable for use as feed, the method comprising:
heating seawater to 50-100 degrees Celsius,
adding eggs and/or trochophores to seawater,
keeping the eggs and/or trochophores in the water for 1-60 seconds, and
separating water from the eggs and/or trochophores.
